(19) United States
(12) Patent Application Publication
(10) Pub. No.: US 2026/0252003 A1
(43) Pub. Date: Aug. 27, 2026

(54) IMAGE FORMING APPARATUS

(71) Applicant: CANON KABUSHIKI KAISHA, Tokyo (JP)

(72) Inventors: YASUKAZU IKAMI, Tokyo (JP); HIROKI TANAKA, Kanagawa (JP); TSUGUHIRO YOSHIDA, Kanagawa (JP); KAZUNARI HAGIWARA, Kanagawa (JP)

(21) Appl. No.: 19/545,794

(22) Filed: Feb. 20, 2026

(30) Foreign Application Priority Data
Feb. 27, 2025 (JP) 2025-030142

(51) Int. Cl. G03G 15/16; G03G 15/01; G03G 21/10

(52) U.S. Cl. CPC G03G 15/161; G03G 15/0131; G03G 15/0184; G03G 15/162; G03G 21/10; G03G 2215/0132; G03G 2221/0005

(57) ABSTRACT

In an image forming apparatus, when a first total toner used amount in a first image forming station is larger than a second total toner used amount in a second image forming station, first toner is supplied to a cleaning blade from the first image forming station via an intermediate transfer belt in a non-image-forming period.

### BACKGROUND

### Field of the Technology

The present disclosure relates to an electrophotographic image forming apparatus such as a laser printer, a copier, or a facsimile.

### Description of the Related Art

In an electrophotographic color image forming apparatus, toner images are sequentially transferred to an intermediate transfer member from image forming units of the respective colors, and the toner images are collectively transferred from the intermediate transfer member to a transfer material. A configuration that uses such a so-called intermediate transfer method has been conventionally known.

In such an image forming apparatus, the image forming units of the respective colors include drum-shaped photosensitive members (hereinafter referred to as photosensitive drums) each serving as an image bearing member. In addition, an intermediate transfer belt formed as an endless belt is widely used as an intermediate transfer member.

Primary transfer members are provided with facing the photosensitive drums via the intermediate transfer belt. These primary transfer members are applied with a voltage from a primary transfer power source. The toner images formed on the photosensitive drums of the respective image forming units are thereby primarily transferred to the intermediate transfer belt. Then, at a secondary transfer portion, a voltage is applied from a secondary transfer power source to a secondary transfer member. The toner images of the respective colors that have been primarily transferred to the intermediate transfer belt from the image forming units of the respective colors are thereby secondarily transferred collectively from the intermediate transfer belt to the transfer material such as paper or an overhead projector (OHP) sheet. The toner images of the respective colors that have been transferred to the transfer material are then fixed by a fixing unit to the transfer material.

In an image forming apparatus of an intermediate transfer method, toner (transfer residual toner) remains on the intermediate transfer belt after toner images are secondarily transferred to a transfer material from an intermediate transfer belt. For this reason, the transfer residual toner remaining on the intermediate transfer belt needs to be removed before a toner image corresponding to the next image is primarily transferred to the intermediate transfer belt.

As a cleaning method of removing transfer residual toner, a blade cleaning method has been widely used. In the blade cleaning method, a cleaning blade is arranged on a downstream side of a secondary transfer portion in a moving direction of an intermediate transfer belt, and comes into contact with the intermediate transfer belt. Transfer residual toner is scraped off by the cleaning blade serving as an abutting member, and can be collected into a cleaning container. In addition, substances to be removed by the cleaning blade are not limited to toner. Paper powder and the like that have fallen from a print sheet are also removed together.

The removing performance caused by the cleaning blade needs to be maintained for a long period of time. For this reason, a technique of supplying toner to a cleaning blade in a non-image-forming period is described in the prior art.

Japanese Patent Laid-Open No. 2020-173310 discusses a configuration in which toner is supplied to a cleaning blade in a non-image-forming period, and an external additive contained in the toner is held in a contact portion between the cleaning blade and an intermediate transfer belt.

### SUMMARY

An aspect of the present disclosure provides an image forming apparatus that includes a first image forming station, a second image forming station, an intermediate transfer belt, an abutting member, a secondary transfer roller, and a toner supply. The first image forming station includes a first photosensitive drum configured to bear at least a portion of an image, a first development container configured to accommodate first toner, a first development roller configured to bear the first toner and develop a first toner image on the first photosensitive drum, and a first primary transfer member. The second image forming station includes a second photosensitive drum configured to bear at least a portion of the image, a second development container configured to accommodate second toner, a second development roller configured to bear the second toner and develop a second toner image on the second photosensitive drum, and a second primary transfer member. The first toner image developed on the first photosensitive drum is primarily transferred to the intermediate transfer belt by the first primary transfer roller. The second toner image developed on the second photosensitive drum is primarily transferred to the intermediate transfer belt by the second primary transfer roller. The first toner image and the second toner image that have been primarily transferred to the intermediate transfer belt are secondarily transferred by the secondary transfer roller to a transfer material. The abutting member is configured to contact the intermediate transfer belt and collect residual toner from the intermediate transfer belt after the first toner image and the second toner image are transferred to the transfer material. An accumulated value of a used amount of first toner in the first image forming station is a first total toner used amount, and an accumulated value of a used amount of second toner in the second image forming station is a second total toner used amount. When the first total toner used amount is larger than the second total toner used amount, first toner is supplied to the abutting member from the first image forming station via the intermediate transfer belt in at least one non-image-forming period. In a region of the intermediate transfer belt to which the first toner image and the second toner image are primarily transferred, one end side in a rotational axis direction of the secondary transfer roller is a first region, and another end side excluding the first region is a second region. When the first total toner used amount is larger than the second total toner used amount in the first region and the first total toner used amount is less than the second total toner used amount in the second region, first toner is supplied in the first region to the intermediate transfer belt from the first image forming station in at least one non-image-forming period, and second toner is supplied in the second region to the intermediate transfer belt from the second image forming station in at least one non-image-forming period.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross section illustrating a configuration of an image forming apparatus according to a first embodiment.

FIG. 2 is a block diagram illustrating operation control of an image forming apparatus according to the first embodiment.

FIG. 3 is a block diagram illustrating an operation of a normal print sequence according to the first embodiment.

FIGS. 4A to 4C are diagrams illustrating a contact state of a cleaning blade and an intermediate transfer belt.

FIG. 5 is a schematic diagram illustrating an overall configuration of an intermediate transfer belt.

FIG. 6 is a diagram illustrating a cross-sectional configuration of an intermediate transfer belt.

FIGS. 7A and 7B are conceptual diagrams illustrating how an external additive and an organosilicon polymer form a stationary layer at a cleaning blade leading end.

FIGS. 8A to 8C are conceptual diagrams illustrating ease of forming a stationary layer at a cleaning blade leading end that depends on a toner particle diameter.

FIGS. 9A and 9B are schematic diagrams illustrating a particle diameter change of toner in a development device that is attributed to the usage of the image forming apparatus.

FIG. 10 is a flowchart illustrating processing for executing a supply sequence.

FIG. 11 is a block diagram illustrating an operation of the supply sequence.

FIG. 12 is a diagram illustrating a divided region for value calculation of a division accumulation counter according to a second embodiment.

### DESCRIPTION OF THE EMBODIMENTS

Hereinafter, a mode for carrying out the present disclosure will be described with reference to the drawings. Nevertheless, the dimensions, materials, and shapes of components to be described in the embodiments, their relative arrangement, and the like are to be appropriately changed depending on the configuration of an apparatus to which the disclosure is applied and various conditions. Accordingly, these are not always intended to limit the scope of the disclosure to the scope described in the embodiments.

### First Embodiment

### (Image Forming Apparatus)

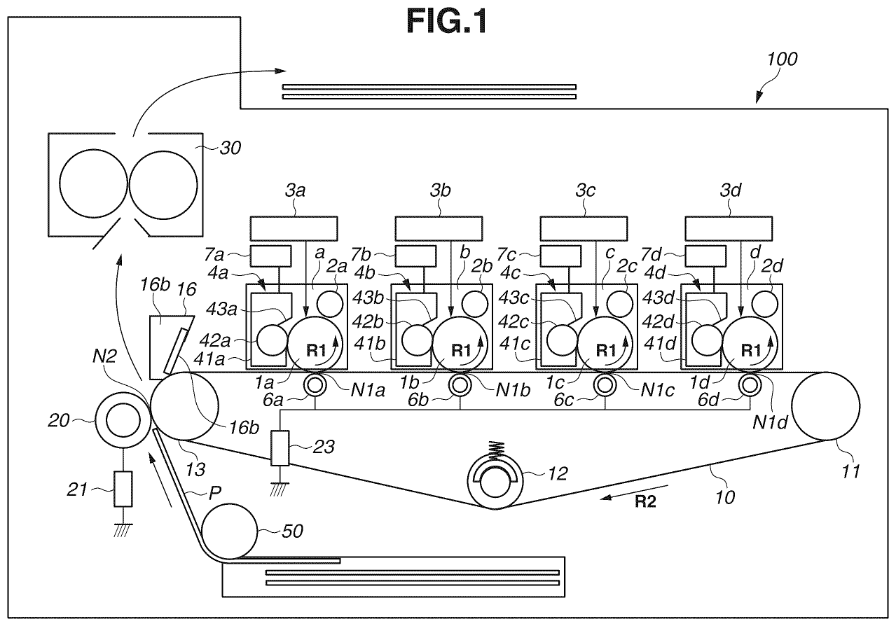

FIG. 1 is a schematic cross section illustrating a configuration of an image forming apparatus 100 according to the present embodiment. The image forming apparatus 100 according to the present embodiment is provided with a plurality of image forming units, also referenced herein as a to d, respectively. The image forming apparatus 100 according to the present embodiment is a so-called tandem-type image forming apparatus. The image forming units a to d (e.g., first image forming station, second image forming station, third image forming station, and fourth image forming station) form images using toners of the respective colors. The toners of the respective colors may be referred to as first toner, second toner, third toner, and fourth toner. The first image forming unit a forms a yellow (Y) image, the second image forming unit b forms a magenta (M) image, the third image forming unit c forms a cyan (C) image, and then, the fourth image forming unit d forms a black (Bk) image. These four image forming units are arranged in a line at regular intervals. Many parts of the configuration are substantially common to these four image forming units except for the color of toner to be accommodated. Thus, a description of the first to fourth first image forming stations a to d of the image forming apparatus 100 is provided with reference to the first image forming unit a, for conciseness.

The first image forming unit a includes a photosensitive drum 1a serving as a drum-shaped photosensitive member, a charging roller 2a serving as a charging member, and a development device 4a. The photosensitive drums of the respective image forming units may be referred to as a first photosensitive drum, a second photosensitive drum, a third photosensitive drum, and a fourth photosensitive drum.

The photosensitive drum 1a is an image bearing member that bears a toner image. The photosensitive drum 1a is rotationally driven at a predetermined process speed (200 mm/sec in the present embodiment) in a direction of an arrow R1 illustrated in FIG. 1. The development device 4a includes a development container 41a, a development roller 42a, and a development blade 43a. The development containers of the respective image forming units may be referred to as a first development container, a second development container, a third development container, and a fourth development container. In addition, the development rollers of the respective image forming units may be referred to as a first development roller, a second development roller, a third development roller, and a fourth development roller. The development container 41a accommodates yellow toner. The development roller 42a is a development member for developing a yellow toner image on the photosensitive drum 1a by bearing yellow toner accommodated in the development container 41a. The development blade 43a is a regulation member that thins toner on the development roller 42a by coming into contact with the development roller 42a. A toner supply container 7a is connected to the development device 4a. The toner supply container 7a accommodates yellow toner to be supplied to the development device 4a. The toner supply containers of the respective image forming units may be referred to as a first toner supply container, a second toner supply container, a third toner supply container, and a fourth toner supply container, collectively referred to as toner supply 7.

From the outside of the image forming apparatus 100, a receiving unit receives an image signal. The received image signal is transmitted to a control unit. An image formation operation is thereby started in the image forming apparatus 100. The photosensitive drum 1a is rotationally driven, and in the rotation process of the photosensitive drum 1a, the photosensitive drum 1a is uniformly charge-processed by the charging roller 2a at a predetermined polarity (negative polarity in the present embodiment) to a predetermined potential (charging potential). Thereafter, the photosensitive drum 1a is subjected to exposure corresponding to the image signal, by an exposure unit 3a. An electrostatic latent image corresponding to an image of a yellow color component of a targeted color image is thereby formed. Subsequently, the electrostatic latent image is developed by a development device 4a at a development position. The electrostatic latent image is visualized as a yellow toner image (hereinafter referred to as a toner image). Here, a normal charging polarity of toner accommodated in the development device 4a is a negative polarity. In this embodiment, the electrostatic latent image is reversely developed using toner charged to the same polarity as a charging polarity of the photosensitive drum charged by the charging member. Nevertheless, the present disclosure can also be applied to an image forming apparatus in which an electrostatic latent image is positively developed using toner charged to a reverse polarity of the charging polarity of the photosensitive drum.

An intermediate transfer belt 10, which is an endless movable intermediate transfer member, is arranged at a position having contact with the photosensitive drums 1a to 1d of the image forming units a to d. The intermediate transfer belt 10 is stretched at three axes corresponding to a support roller 11, a stretching roller 12, and a counter roller 13, which serve as stretching members. The intermediate transfer belt 10 is stretched by the stretching roller 12 with a total tension of 60 N. The intermediate transfer belt 10 moves in an arrow R2 direction illustrated in FIG. 1, by the rotation of the counter roller 13 rotating upon receiving drive force. The intermediate transfer belt 10 in the present embodiment includes a plurality of layers, which will be described in detail below.

A toner image formed on the photosensitive drum 1a passes through a primary transfer portion N1a where the photosensitive drum 1a and the intermediate transfer belt 10 have contact with each other. In this process, a positive-polarity voltage is applied from a primary transfer power source 23 to a primary transfer roller 6a, and the toner image is primarily transferred to the intermediate transfer belt 10 by the voltage. The primary transfer rollers of the respective image forming units may be referred to as a first primary transfer roller, a second primary transfer roller, a third primary transfer roller, and a fourth primary transfer roller. The toner images of the respective image forming units may be referred to as a first toner image, a second toner image, a third toner image, and a fourth toner image.

Here, the primary transfer roller 6a is provided at a position where the primary transfer roller 6a faces the photosensitive drum 1a via the intermediate transfer belt 10. The primary transfer roller 6a is a primary transfer member that comes into contact with an inner circumferential surface of the intermediate transfer belt 10. In addition, the primary transfer power source 23 is a power source. The primary transfer power source 23 can apply a voltage with a positive polarity or a negative polarity to the primary transfer roller 6a to 6d. In the present embodiment, a configuration is employed that applies a voltage to a plurality of primary transfer members from a common primary transfer power source 23. Nevertheless, the configuration is not so limited, and the present disclosure can also be applied to a configuration in which a plurality of primary transfer power sources corresponding to the respective primary transfer members are provided.

Hereinafter, similarly to a yellow toner image having a first color, a magenta toner image having a second color, a cyan toner image having a third color, and a black toner image having a fourth color are formed. These toner images are sequentially transferred to the intermediate transfer belt 10 in an overlaid manner. Four-color toner images corresponding to the targeted color image are thereby formed on the intermediate transfer belt 10. Thereafter, the four-color toner images formed and borne on the intermediate transfer belt 10 pass through a secondary transfer portion formed by a secondary transfer roller 20 and the intermediate transfer belt 10 having contact with each other. In the process, these toner images are secondarily transferred collectively to the surface of a transfer material P, such as paper or an OHP sheet, fed by a sheet feeding unit 50.

As the secondary transfer roller 20, a roller having an external diameter of 18 mm obtained by covering a nickel-plated steel rod having an external diameter of 8 mm with a foam sponge member is used. The foam sponge member contains, as main components, nitrile-butadiene rubber (NBR) and epichlorohydrin rubber adjusted to have a volume resistivity of 10⁸ Ωcm and a thickness of 5 mm. The rubber hardness of the foam sponge member was measured using Asker Durometer Type C and the rubber hardness was a hardness of 30° when the load was 500 g. The secondary transfer roller 20 has a contact with the outer circumferential surface of the intermediate transfer belt 10. The counter roller 13 is arranged at a position facing the secondary transfer roller 20 via the intermediate transfer belt 10. The secondary transfer roller 20 is pressed against the counter roller 13 with pressing force of 50 N. A secondary transfer portion N2 is thereby formed.

The secondary transfer roller 20 rotates by being driven by the intermediate transfer belt 10. By a voltage being applied from a secondary transfer power source 21, a current flows from the secondary transfer roller 20 toward the counter roller 13. The toner image borne on the intermediate transfer belt 10 is thereby secondarily transferred to the transfer material P at the secondary transfer portion. When the toner image on the intermediate transfer belt 10 is secondarily transferred to the transfer material P, control is performed such that the current flowing from the secondary transfer roller 20 toward the counter roller 13 via the intermediate transfer belt 10 becomes constant. The control is performed by the control of the voltage applied from the secondary transfer power source 21 to the secondary transfer roller 20. In addition, the magnitude of the current for performing secondary transfer is preliminarily determined depending on a surrounding environment where the image forming apparatus 100 is installed and the type of the transfer material P. The secondary transfer power source 21 is connected to the secondary transfer roller 20.

The secondary transfer power source 21 applies a transfer voltage to the secondary transfer roller 20. In addition, the secondary transfer power source 21 can output a transfer voltage in a range from 100 [V] to 4000 [V].

The transfer material P to which the four-color toner images have been transferred by secondary transfer is then heated and pressed in a fixing unit 30. The four-color toner images are thereby melted and mixed, and fixed on the transfer material P. Toner left on the intermediate transfer belt 10 after secondary transfer is cleaned and removed by a belt cleaning unit 16 (collection unit). The belt cleaning unit 16 is provided on the downstream side of the secondary transfer portion N2 in the moving direction of the intermediate transfer belt 10 such that the toner is collectable. The belt cleaning unit 16 includes a cleaning blade 16a and a waste toner container 16b. The cleaning blade 16a is an abutting member that comes into contact with a circumference surface of the intermediate transfer belt 10 at a position where the cleaning blade 16a faces the counter roller 13. The waste toner container 16b accommodates toner collected by the cleaning blade 16a. In the following description, the cleaning blade 16a will simply be referred to as a blade 16a.

In the image forming apparatus 100 according to the present embodiment, a full-color print image is formed through the above-described operations.

### (Control Block)

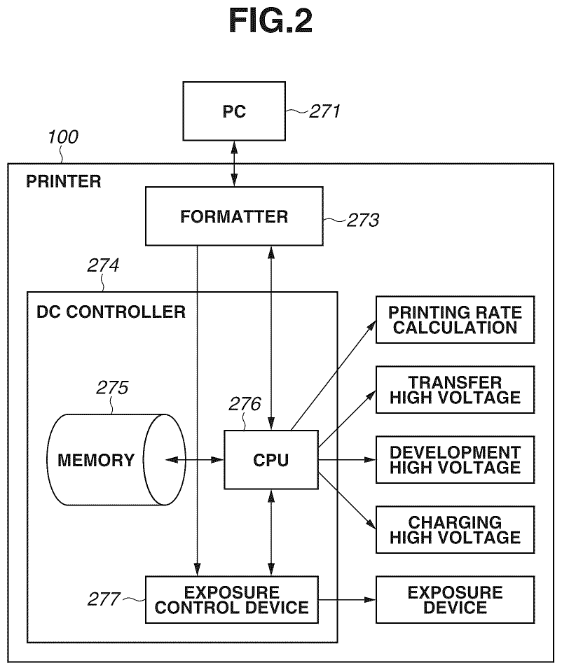

FIG. 2 is a control block diagram illustrating blocks for controlling an operation of an image forming apparatus. A personal computer (PC) 271, which is a host computer, transmits a print command and image data of an image to be printed, to a formatter 273 included in the image forming apparatus 100. The formatter 273 converts the image data from the PC 271 into exposure data. The formatter 273 transfers the exposure data to an exposure control device 277 included in a direct-current (DC) controller 274. The exposure control device 277 performs the control of an exposure unit by controlling on/off of exposure data based on an instruction from a central processing unit (CPU) 276. In the image forming apparatus 100, as illustrated in FIG. 2, halftone control is performed by the adjustment of exposure data. The adjustment is adjustment of an on area and an off area in the exposure data. The on area is an area to be exposed, and the off area is an area not to be exposed. When the CPU 276 receives a print command from the formatter 273, the CPU 276 starts an image formation sequence. The DC controller 274 is equipped with the CPU 276, a memory 275, and the like. The formatter 273 is similarly equipped with a CPU, a memory, a bus connecting these, and the like as well. The DC controller 274 performs a preprogramed operation. The CPU 276 controls a charging high voltage, a development high voltage, and a transfer high voltage. The CPU 276 thereby controls the formation of an electrostatic latent image, the transfer of a developed toner image, and the like, whereby image formation is performed.

In addition, the CPU 276 has a function of calculating an image coverage of each color based on image data. Various high voltages and operation sequences can be adjusted in accordance with the image coverage. The image coverages of the respective colors may also be referred to as a first image coverage, a second image coverage, a third image coverage, and a fourth image coverage.

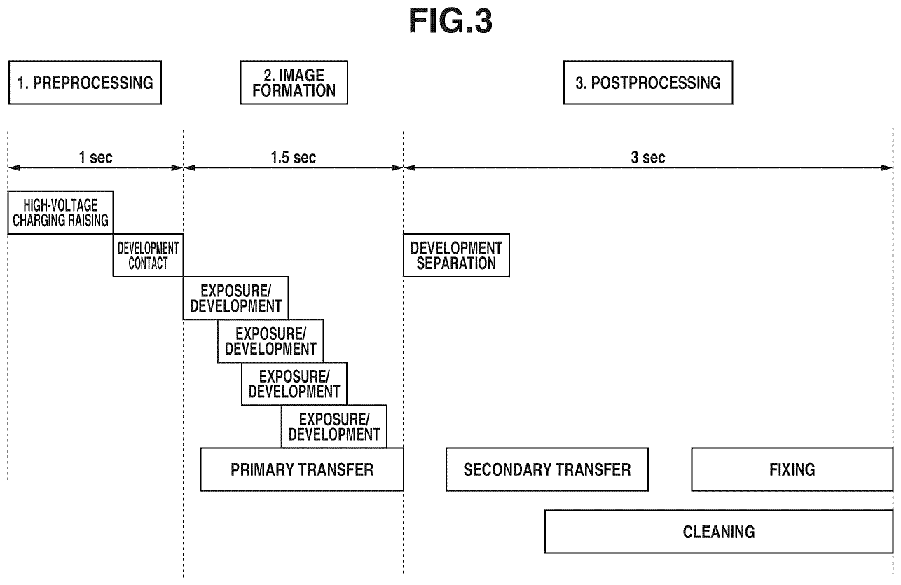

FIG. 3 is a diagram illustrating a timing chart of representative operations of a normal printing sequence. A case of printing one A4 sheet will be described as an example.

In a preprocessing operation, the development roller 42 comes into contact with the photosensitive drum 1 after the charging high voltage rises. A time for the preprocessing operation is 1 sec. Next, in an image formation operation, development and primary transfer are performed. A time for the image formation operation is 1.5 sec. Next, in a postprocessing operation, the development roller 42 is separated from the photosensitive drum 1 together with the execution of secondary transfer and the fixing operation. The cleaning of residual toner on the intermediate transfer belt 10 is also performed. When the cleaning ends, a rotation operation of the intermediate transfer belt 10 is promptly stopped. A time for the postprocessing operation is 3 sec.

In a case where a toner remaining amount in a development device falls below a threshold, toner is conveyed from the toner supply container 7 to the development device 4, and toner supply is performed. Toner supply is performed during the postprocessing operation.

The toner remaining amount can be calculated from an image coverage calculated by the CPU 276, which may also calculate a toner supplied amount and an amount of toner in the development device 4 after toner supply.

### (Belt Cleaning Unit)

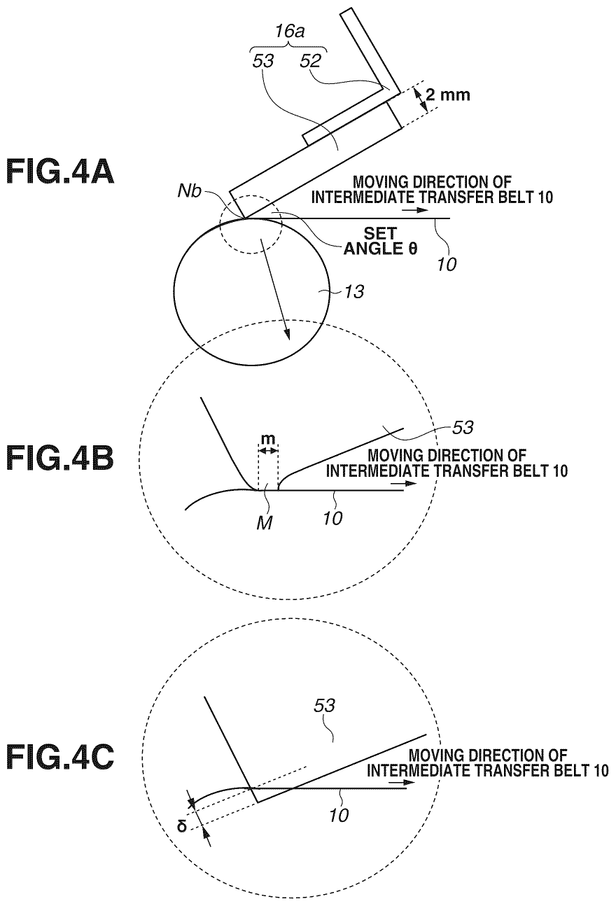

FIG. 4A is a schematic diagram illustrating a contact state of the blade 16a and the intermediate transfer belt 10. FIG. 4B is a schematic diagram illustrating a contact point of the blade 16a and the intermediate transfer belt 10 in an enlarged manner. The blade 16a in the present embodiment is a plate-like member longer in a width direction of the intermediate transfer belt 10 (hereinafter referred to as a belt width direction). The belt width direction intersects with a moving direction of the intermediate transfer belt 10 (hereinafter referred to as a belt conveyance direction).

The blade 16a in the present embodiment includes an elastic portion 53 that comes into contact with the intermediate transfer belt 10 and scrapes off toner, and a sheet metal portion 52 supporting the elastic portion 53. The elastic portion 53 is a blade member formed of polyurethane. The blade 16a has a blade shape in which a width of the elastic portion 53 that comes into contact with the intermediate transfer belt 10 is a length of 230 mm. The elastic portion 53 and the sheet metal portion 52 of the blade 16a are bonded. The elastic portion 53 of the blade 16a is longer—in the belt width direction of 230 mm and a thickness of 2 mm. The elastic portion 53 has a free length of 13 mm, which is a length from a point where the elastic portion 53 is bonded with the sheet metal portion 52. In addition, the hardness of the blade 16a is 77 degrees according to a JIS K 6253 standard.

On the inner circumference side of the intermediate transfer belt 10, the counter roller 13 is arranged so as to face the blade 16a. The blade 16a is arranged toward a counter direction with respect to the belt conveyance direction, and has contact with the surface of the intermediate transfer belt 10. That is, the blade 16a has contact with the surface of the intermediate transfer belt 10 in such a manner that a free end is oriented toward an upstream side, in the belt conveyance direction. A blade nip portion Nb as illustrated in FIG. 4A, is thereby formed between the blade 16a and the intermediate transfer belt 10. The blade 16a scrapes toner off the surface of the moving intermediate transfer belt 10 at the blade nip portion Nb and collects the toner as waste toner into the waste toner container 16b. In the present embodiment, a width of the blade nip portion Nb where the blade 16a and the intermediate transfer belt 10 have contact with each other is 75 μm in the belt conveyance direction.

In the configuration of the present embodiment, as illustrated in FIG. 4B, the blade 16a is arranged in the counter direction with respect to the belt conveyance direction. For this reason, a leading end portion of the blade 16a contacts the intermediate transfer belt 10 receives frictional force in the belt conveyance direction. The frictional force received by the leading end portion of the blade 16a becomes force in a direction of bending the leading end portion of the blade 16a in the belt conveyance direction in such a manner as to follow the belt. Consequently, the contact portion of the blade 16a is bent by the frictional force at the contact portion, as illustrated in FIG. 4B, and the shape of a distal end of the blade 16a changes to correspond to a shape of the intermediate transfer belt 10, i.e., an entangled shape. When viewed as illustrated in FIG. 4B, a region where the blade 16a is entangled is an entangled portion M, and a distance (length) of the entangled portion M in the belt conveyance direction is an entangled amount m. FIG. 4C illustrates a configuration in which an intermediate transfer belt does not exist at a position where the blade 16a comes into contact with and is not pushed in the intermediate transfer belt 10. The virtual line illustrated in FIG. 4C is drawn along a shape obtainable by the blade 16a extends, without contact with an intermediate transfer belt 10 and without being bent. In a virtual shape of the blade 16a that extends along the virtual line, a maximum depth at which the blade 16a invades the counter roller 13 in a thickness direction of the blade that extends along the blade leading end surface is an invasion amount δ.

Pressure applied from the blade 16a to the intermediate transfer belt 10 concentrates on the entangled portion M. This can prevent toner reaching the blade 16a, from dropping from the blade 16a. Eventually, a cleaning failure is prevented.

In the present embodiment, the blade 16a is arranged with respect to the intermediate transfer belt 10 in such a manner that a set angle θ becomes 22°, the invasion amount δ becomes 1.5 mm, and a contact pressure becomes 20 N. Here, the set angle θ is defined at an intersection point obtainable when it is virtually assumed that the intermediate transfer belt 10 and the blade 16a do not have contact with each other nor are bent, and is an angle formed by the blade 16a and a tangent line of the counter roller 13 at the intersection point. The intersection point is an intersection point with an end surface on the free end side of the blade 16a. In addition, the set angle θ is an angle formed by one of surfaces of the blade 16a that substantially orthogonal to each other in the thickness direction, and the above-described tangent line of the counter roller 13.

The invasion amount δ is a length in the thickness direction by which the blade 16a virtually overlaps the counter roller 13. The contact pressure is a pressing force from the blade 16a at the blade nip portion Nb (linear pressure in a longer direction). The contact pressure is measured using a film-type pressure measurement system (e.g., PINCH, manufactured by NITTA Corporation).

The entangled portion M of the blade 16a that has been entangled by frictional force between the blade 16a and the intermediate transfer belt 10 applies pressure to the intermediate transfer belt 10. Toner left on the intermediate transfer belt 10 is thereby banked up by the blade 16a. Thereafter, the toner banked up by the blade 16a is collected into the waste toner container 16b. Accordingly, the collectability of toner is ensured by the blade 16a having contact by applying predetermined pressure to the intermediate transfer belt 10 in such a manner as to prevent toner from dropping.

### (Intermediate Transfer Belt)

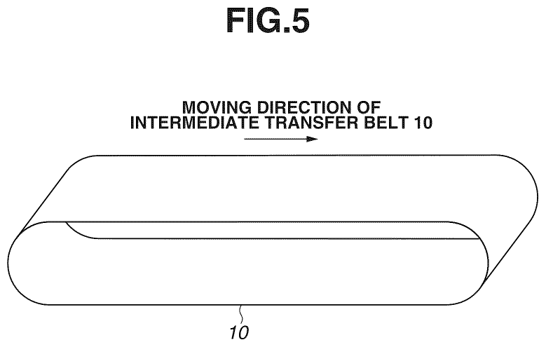

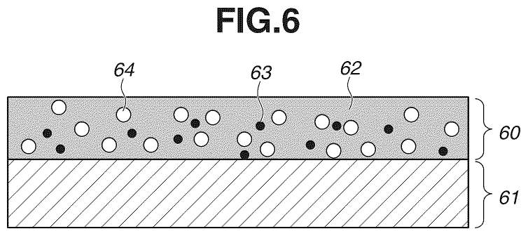

FIG. 5 is a schematic diagram illustrating an overall configuration of the intermediate transfer belt 10. FIG. 6 is a diagram illustrating a cross-sectional configuration of the intermediate transfer belt 10, and is a partial enlarged schematic view of a cross-section. FIG. 6 is a diagram illustrating a cross-section obtained by cutting the intermediate transfer belt 10 in a direction orthogonal to the belt conveyance direction (cross-section viewed along the belt conveyance direction).

The intermediate transfer belt 10 is an endless belt member (or a film-shaped member) including two layers corresponding to a base layer 61 and a surface layer 60. A circumferential length of the intermediate transfer belt 10 is 700 mm, and a longer-direction width in the belt width direction is 250 mm. Here, the base layer is the thickest layer among layers included in the intermediate transfer belt 10, in the thickness direction of the intermediate transfer belt 10. In the present embodiment, the base layer 61 is a layer in which quaternary ammonium salt, which is an ion conductor, is dispersed in polyethylene naphthalate resin as an electrical resistance adjuster, and is a layer with a thickness of 70 μm.

The material of the base layer 61 is not limited to the above-described material. Examples of the materials of the base layer 61 include, aside from polyethylene naphthalate resin, thermoplastic resins, such as polycarbonate, polyvinylidene fluoride (PVDF), polyethylene, polypropylene, polymethylpentene-1, polystyrene, polyamide, polysulfone, polyarylate, polyethylene terephthalate, polybutylene terephthalate, polyethylene naphthalate, polyphenylene sulfide, polyethersulfone, polyethernitrile, thermoplastic polyimide, polyetheretherketone, thermotropic liquid crystal polymer, and polyamide acid. These can also be used by mixing two or more types. In addition, as an ion conductor to be added to the base layer 61, ionic liquid, a conductive oligomer, quaternary ammonium salt, and the like can also be used. From among these conductive materials, one type or more may be appropriately selected, or an electronically conductive material and an ion conductive material may also be mixedly used.

The surface layer 60 is formed on the outer circumferential surface side of the intermediate transfer belt 10. The surface layer 60 in the present embodiment is a layer in which antimony-doped zinc oxide serving as an electrical resistance adjuster 63 is dispersed in acrylic resin serving as a base material 62. Polytetrafluoroethylene (PTFE) particles, which are fluorine-containing particles, are added to the surface layer 60 as a solid lubricant 64. The thickness of the surface layer 60 is 3 μm. In the present embodiment, PTFE particles are added by 20 parts by weight.

Regarding the base material 62 of the surface layer 60, curable resin, such as melamine resin, urethane resin, alkyd resin, fluorine-based curable resin (fluorine-containing curable resin), is included as an organic material other than acrylic resin. As an inorganic material, an alkoxysilane/alkoxyzirconium-based material, a silicate-based material, and the like are included. Organic-inorganic hybrid materials include an organic polymer-based material with dispersed inorganic particles, an organoalkoxysilane-based material with dispersed inorganic particles, an acrylic silicon-based material, an organoalkoxysilane-based material, and the like.

In addition, as a conductive material to be added to the surface layer 60, in addition to the foregoing, particulate, fibrous, or flake-shaped carbon-based conductive fillers are included, such as carbon black, PAN-based carbon fibers, and expanded graphite pulverized products. In addition, particulate, fibrous, or flake-shaped metallic conductive fillers are also included, such as silver, nickel, copper, zinc, aluminum, stainless steel, and iron. In addition, particulate metal oxide-based conductive fillers are also included, such as zinc antimonate, antimony-doped tin oxide, antimony-doped zinc oxide, tin-doped indium oxide, and aluminum-doped zinc oxide.

From the viewpoint of strength such as wear resistance and crack resistance of the surface layer 60, a resin material (curable resin) may be among curable materials. In addition, among curable resins, acrylic resin obtained by curing an acrylic copolymer containing an unsaturated double bond may be the surface layer 60. The surface layer 60 of the present embodiment is obtained by applying liquid containing an ultraviolet curable monomer and/or an oligomer component on the surface of the base layer 61, and curing the liquid by emitting energy beams such as ultraviolet rays to the surface.

A volume resistivity of the intermediate transfer belt 10 in the present embodiment is 1×10¹⁰ Ωcm.

The volume resistivity was measured at an applied voltage of 100 V and for a measurement time of 10 seconds by connecting a UR probe (model type MCP-HTP12) of the Hiresta-UP (MCP-HT450) of Mitsubishi Chemical Corporation to the intermediate transfer belt 10. The environment of a measurement room in which the volume resistivity is measured during measurement is set to a temperature of 23° C. and a humidity of 50%, and the volume resistivity of the intermediate transfer belt 10 left in the measurement room for four hours was measured.

### (Toner)

Toner to be used in the image forming apparatus and a manufacturing method of toner are described below, without limitation thereto.

Manufacturing methods of toner base particles include a suspension polymerization method, solution suspension method, and an emulsion coagulation method that manufacture resin particles within an aqueous medium. Among these, the suspension polymerization method may be a manufacturing method of toner base particles. Because toner manufactured by the suspension polymerization method has a high circularity and its shape is highly uniform, the toner is good in flowability and good image quality is obtained.

The suspension polymerization method obtains toner base particles by polymerizing a polymerizable monomer contained in a polymerizable monomer composition. The polymerizable monomer composition contains a polymerizable monomer that can generate resin, and a mold release agent, and other additives as necessary, and is granulated in an aqueous medium.

In addition, after the end of a polymerization process, particles generated by a known method such as cleaning or filtration are collected, and toner base particles may be obtained by drying the particles.

In a latter half of the polymerization process, heating may be performed, and temperature may be raised. In the latter half of the polymerization process or after the end of the polymerization process, partial dispersing media can also be distilled away from a reaction system, and an unreacted polymerizable monomer or a by-product can also be removed.

Toner base particles may be manufactured in an aqueous medium, and a protruding portion containing an organosilicon polymer to be described below is formed on the surface of the toner base particles.

Toner including a protruding portion containing an organosilicon polymer, which is suitable for toner in the present embodiment, will be described. The toner is toner in which an organosilicon polymer represented by Equation (1), below, is contained on the toner particle surface.

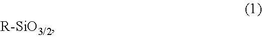

with R denoting an alkyl or phenyl group having one to six carbon atoms.

In a partial structure represented by Equation (1), Si atom has four valence electrons, one of which is bonded to an organic group represented by R, while the remaining three are bonded to oxygen atoms. O atoms form a siloxane bond (Si—O—Si) where two valence electrons are both bonded to Si atoms. In the partial structure represented by Equation (1), three O atoms exist for every two Si atoms in the relationship between Si atoms and O atoms as organosilicon polymers. For this reason, the structure is represented as —SiO_{3/2}. That is, the structure becomes a structure as represented by the following structural Equation (2), below.

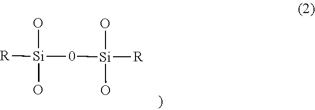

The structure of —SiO_{3/2} of the organosilicon polymer is considered to have a property similar to silica (SiO₂) having a number of siloxane structures, and environmental stability, an effect of suppressing a charge reversal component, and their durability become good by having the above-described structure on the surface. When toner reaches the blade 16a, a surface layer containing an organosilicon polymer shifts to the vicinity of a cleaning nip Nb. Then, the surface layer containing an organosilicon polymer prevents toner from being directly sandwiched between the blade 16a and the intermediate transfer belt 10. Thus, the behavior of the blade 16a can be stabilized.

Toner may be manufactured by adding and mixing an external additive to toner particles by using a known method (e.g., Henschel Mixer (FM10C) manufactured by Nippon Coke & Engineering Co., Ltd. or the like is used).

Chargeability and flowability of toner may thus be changed. Because the external additive similarly shifts to the vicinity of the cleaning nip Nb when toner reaches the blade 16a, the behavior of the blade 16a can be stabilized.

### (Adhering of External Additive and Organosilicon Polymer to Blade)

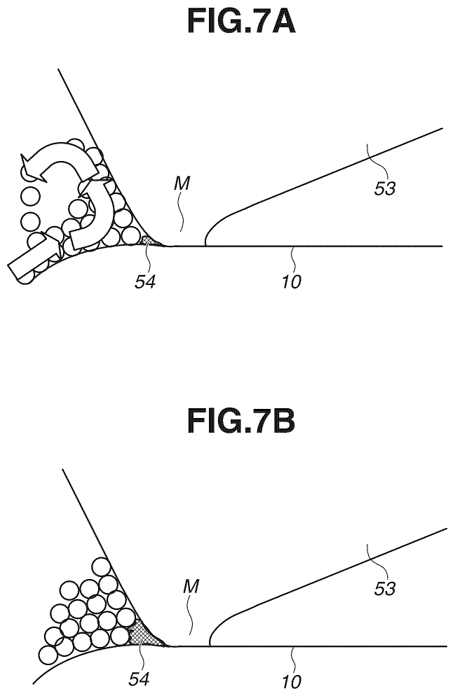

An external additive added to toner in the present embodiment, and a protruding portion containing an organosilicon polymer that is formed in toner base particles have a property of shifting from the toner base particles to the blade 16a after toner is collected by the blade 16a. This is because, as illustrated in FIG. 7A, collected toner base particles get closely spaced in the vicinity of a cleaning member and rub against one another, and a shift occurs at the time. The shift gradually progresses in accordance with the number of times toner base particles rub against one another. For this reason, an external additive and particles of an organosilicon polymer separated from toner base particles may shift to the vicinity of the contact portion of the blade 16a, by the toner base particles getting closely spaced in the vicinity of the cleaning member and rubbing against one another for a certain period of time or more.

The shifted external additive and organosilicon polymer particles are brought into pressure contact between the intermediate transfer belt 10 and the elastic portion 53 of the blade 16a, and a stationary layer 54 that stably gets still is formed. The stationary layer 54 prevents toner base particles from being directly entangled in a nip portion, and eventually, toner dropping is prevented. In addition, the stationary layer 54 adheres to the entangled portion M in the longer direction of the blade 16a, and acts as a lubricant. This prevents the wear and the peel-off of the elastic portion 53 of the blade 16a.

On the other hand, in a case where amounts of an external additive and an organosilicon polymer adhering to the blade 16a are not sufficiently large, and there is concern that the nip portion Nb and the intermediate transfer belt 10 coming into direct contact with each other. There is concern that the wear of the blade 16a in the entangled portion M is accordingly promoted. In addition, in a case where the nip portion Nb and the intermediate transfer belt 10 come into the above-described direct contact with each other, frictional force applied to the leading end of the blade 16a becomes large. For this reason, the entangled amount m of the entangled portion M of the blade 16a, which is the amount described with reference to FIG. 4B also becomes large. If the entangled amount m becomes too large, there is concern that peel-off occurs toward the downstream side in the belt conveyance direction in the blade 16a, which is in contact with the intermediate transfer belt 10 in the counter direction.

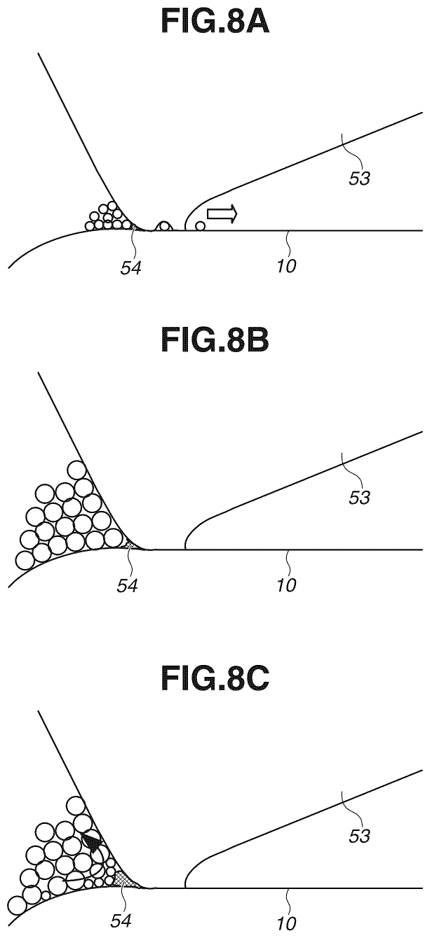

As described above, to shift an external additive to the vicinity of the cleaning nip Nb by circulating toner supplied to the blade 16a, the toner needs to stay in the vicinity of the cleaning nip Nb for a certain period of time. On the other hand, suspension-polymerized toner to be used in the present embodiment has high circularity. Thus, the suspension-polymerized toner, which is toner having a small spherical particle diameter, easily gets under the contact portion of the blade 16a and the intermediate transfer belt 10, and easily drops therefrom. As illustrated in FIG. 8A, the suspension-polymerized toner easily reaches the vicinity of the entangled portion M of the blade 16a. Part of the suspension-polymerized toner is bitten in between the blade 16a and the intermediate transfer belt 10. Then, the suspension-polymerized toner drops toward the downstream side of the blade nip portion Nb by frictional force applied at the time. When the suspension-polymerized toner drops, the suspension-polymerized toner removes the stationary layer 54 of an external additive and an organosilicon polymer that is interposed in the vicinity of the blade nip portion Nb, from the blade 16a.

For this reason, in this portion where suspension-polymerized toner drops toward the downstream side of the blade nip portion Nb, toner dropping might occur in a chain manner. On the other hand, as illustrated in FIG. 8B, even if toner is spherical toner, the toner is likely to stay without dropping from the blade 16a as long as a particle diameter is large. By circulating remaining toner, an external additive and an organosilicon polymer shift to the vicinity of the cleaning nip Nb, and the stationary layer 54 is formed. The behavior of the blade 16a with respect to the peel-off is thereby stabilized. For this reason, in an application sequence in which an external additive and an organosilicon polymer are applied to the vicinity of the cleaning nip Nb, toner with a large particle diameter may be selectively supplied. If the stationary layer 54 is appropriately formed, toner dropping is prevented.

Even if toner containing particles with a small particle diameter reaches the blade 16a as illustrated in FIG. 8C, the stationary layer prevents toner from being directly bitten in between the blade 16a and the intermediate transfer belt 10.

### (Adjustment of Amount by Which Toner Adheres to Blade)

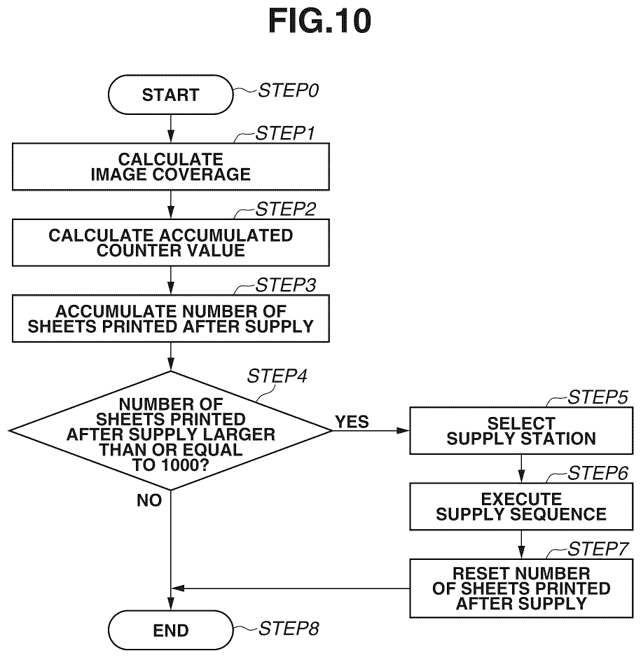

FIG. 10 is a flowchart illustrating adhering amount adjustment sequences. Calculation processing in these sequences is executed by the formatter 273 described with reference to the control block diagram in FIG. 2.

In STEP1, image coverages of yellow, magenta, cyan, and black are calculated based on print job information transmitted from the PC 271.

In STEP2, an accumulated counter value of each station is calculated using Equation (3), below, in accordance with the image coverage calculated in STEP1.

$$Accumulated counter value = Σ ( coefficient \times image coverage ) \qquad ( 3 )$$

The coefficient in Equation (3) indicates a toner used amount for an image coverage of 1% and for one printed sheet. The coefficient may include information such as continuous printing/intermittent printing, an image pattern, a printing environment, and a difference among image forming stations. For example, in the case of executing continuous printing using yellow toner at room temperature from 20° C. to 27° C., the coefficient is 3 [mg/%/sheet]. Coefficient×image coverage denotes a toner used amount for one printed sheet.

In STEP 3, the number of sheets printed from the previous supply sequence is accumulated based on the print job information transmitted from the PC 271.

In STEP4, it is determined whether the number of sheets printed from the previous supply sequence is larger than or equal to 1000. In a case where a calculation result obtained in STEP4 indicates the number is less than 1000 (NO in STEP4), the processing proceeds to STEP8, and the sequence ends. The next print job information is transmitted from the PC 271, and the image forming apparatus 100 waits until the next print job is started.

In a case where a calculation result obtained in STEP4 is larger than or equal to 1000 (YES in STEP4), the processing proceeds to STEP5.

In STEP5, an image forming station to be used in the supply sequence is selected. An image forming station having the largest accumulated counter value when accumulated counter values of the respective image forming stations are compared is selected as a supply station L. In a case where accumulated counter values of a plurality of stations are equal, the plurality of stations may be selected as supply stations L.

In STEP6, the supply sequence is executed.

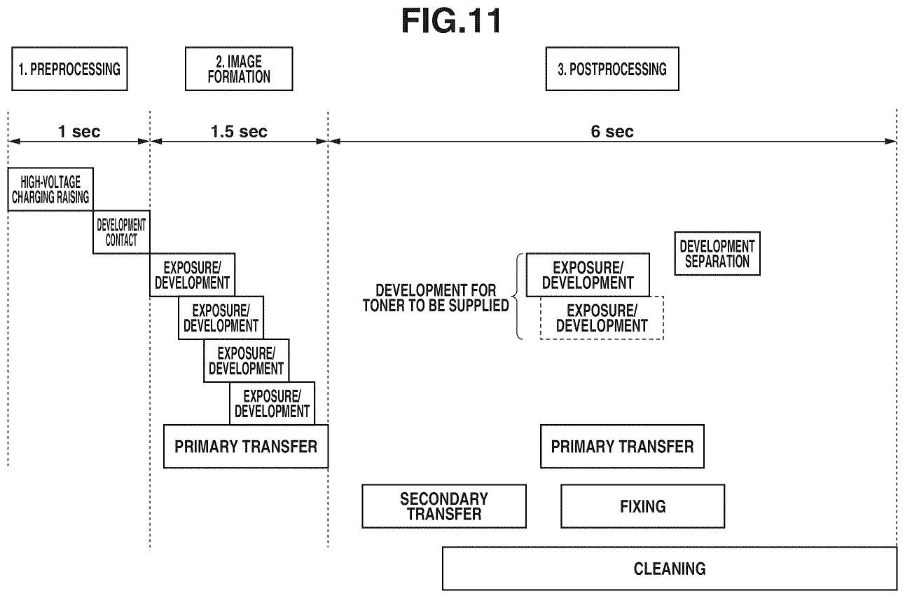

FIG. 11 illustrates a timing chart of a representative operation of a print sequence to be executed in a case where the supply sequence is executed. When a print job in which the number of sheets printed from the previous sequence is larger than or equal to 1000 ends, the supply sequence is executed.

In FIG. 11, a case where a development operation for toner to be supplied is performed in one image forming station is indicated by a solid line. In the configuration illustrated in FIG. 1, the exposure unit 3 of the station L (FIG. 10, STEP10) exposes the photosensitive drum 1 at a timing at which toner of a print job of which an image has been primarily transferred onto the intermediate transfer belt 10 passes through a secondary transfer portion. Thereafter, the development device 4a performs an operation equivalent to executing printing using all black with a width of 32 mm in the belt conveyance direction.

The development of toner is performed by two image forming stations during one supply sequence, with an exposure/development operation performed by the second image forming station at a timing indicated by a broken line block in FIG. 11.

In a case where a plurality of stations is selected as supply stations L in STEP5 of FIG. 10, a region with a length of 32 mm in which printing is executed using all black toner is divided into regions for the respective colors in accordance with the number of stations. For example, it is assumed that magenta M and cyan C are selected as supply stations L. In this case, 16-mm regions are printed in the respective colors, and these toners are supplied to the blade 16a. At this time, an image formation timing at which an image is formed on the intermediate transfer belt 10 varies among stations. Accordingly, a plurality of colors are not overlaid on the belt. When the development operation of supplied toner ends, the development roller 42 is separated from the photosensitive drum 1.

The supplied toner primarily transferred onto the intermediate transfer belt 10 needs to be prevented as much as possible from adhering to the secondary transfer roller 20 to which a toner image is to be secondarily transferred. For this reason, in synchronization with a reach timing at which the supplied toner reaches the secondary transfer roller 20, voltage is applied to the secondary transfer roller 20. The voltage is applied such that toner regularly charged to a regular polarity receives coulomb force applied toward the intermediate transfer belt 10 side.

At a time point at which the supplied toner reaches the blade 16a, a supply operation ends. The driving of intermediate transfer and the application of various types of high-voltage power are accordingly stopped. In the present embodiment, as described above, the sequence has ended at a timing at which supplied toner reaches the blade 16a, and there is a possibility that the shift of an external additive and an organosilicon polymer to the blade 16a has not completely performed. Nevertheless, when the intermediate transfer belt 10 is driven again in the next print job or the like, shift is performed again, and the shift is completely performed.

In STEP7 of FIG. 10, the number of printed sheets counter for managing an interval between supply operations is reset.

A toner supply station is selected based on such a standard will be described.

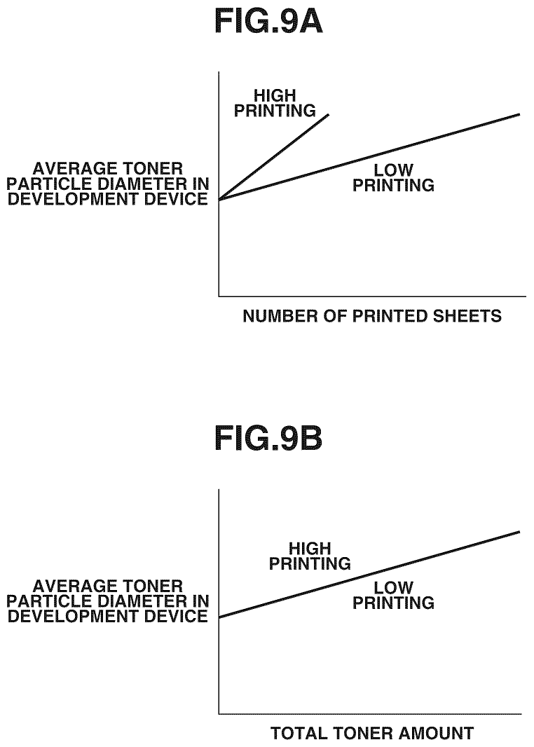

In a development device included in an image forming apparatus as described in the present embodiment, a particle diameter of toner to be developed on a photosensitive drum is small in the initial stage, and gradually increases as toner is used. That is, in the initial usage stage of the development device, toner to be developed on a photosensitive drum is smaller than an average particle in diameter of toner initially supplied to the development device. Thereafter, toner to be developed on a photosensitive drum gradually increases as toner is used. The degree of a particle diameter change depends on a toner used amount in the development device, and the influence of an image coverage on the degree of a particle diameter change is small. FIGS. 9A and 9B illustrate conceptual diagrams of this phenomenon.

As illustrated in FIG. 9A, an average toner particle diameter in the development device increases as the number of printed sheets increases, and becomes larger in the case of high-coverage printing, compared to low-coverage printing. Image coverage is larger in high-coverage printing, and a total toner used amount is also larger. If the horizontal axis in FIG. 9B indicates a number of printed sheets, rather than a total toner used amount, an average toner particle diameter in the development device increases as a total amount of toner that is used increases, with no difference between low-coverage printing and high-coverage printing.

Accordingly, instead of directly using an image coverage as a standard, an accumulated counter value corresponding to a total toner used amount is used. An amount reflecting an average particle diameter of toner contained in the development device is thereby obtained. With this configuration, as illustrated in FIGS. 8A to 8C, toner of a station in which the stabilization of the behavior of the blade is efficiently performed in this manner is preferentially used. By supplying toner in this manner, supplied toner is saved and the behavior of the blade is stabilized. The total toner used amounts of the respective image forming units may be referred to as a first total toner used amount, a second total toner used amount, a third total toner used amount, and a fourth total toner used amount.

The case of the configuration of supplying toner to the development device will now be described. In a state immediately before the supply, an average particle diameter of toner remaining in the development device becomes larger as compared with that of new toner. By new toner being supplied in this state, an average toner particle diameter in the development device after supply becomes a size between those of residual toner and new toner. In view of the foregoing, at the time of a supply operation, an accumulated counter value is corrected by Equation (4), below.

$$y = w\_before / w\_after \times x \qquad ( 4 )$$

When an accumulated counter value obtainable immediately before supply is denoted by x, a toner amount in a development container that is obtainable immediately before supply is denoted by w_before, and a toner amount in a development container that is obtainable after supply is denoted by w_after, an accumulated counter value y obtainable after supply is calculated by Equation (4), above.

The accumulated counter value y obtainable after supply is obtained by multiplying a toner amount in a development container that is obtainable before supply/toner amount in a development container that is obtainable after supply by an accumulated counter value obtainable immediately before supply.

It is assumed that a toner amount in a development container that is obtainable immediately before supply is 30 g, a toner amount in a development container that is obtainable after supply is 100 g, and an accumulated counter value obtainable immediately before supply is 100. In this case, an accumulated counter value obtainable immediately after supply becomes 30. In a print job after supply, until toner supply is performed again, an accumulated counter value is updated using the following method. A value corresponding to an image coverage is added to y in accordance with Equation (5), below, and the accumulated counter value is updated.

$$Accumulated counter value = y + Σ ( coefficient \times image coverage ) \qquad ( 5 )$$

By the accumulated counter value being updated in accordance with Equation (5), above, an accumulated counter value reflecting a change in particle diameter of toner in the development container is obtained.

A case will be described in which an execution interval between supply sequences is increased to suppress the number of times of a supply sequence. In this case, amounts by which an external additive and an organosilicon polymer are shifted to the blade 16a during a postprocessing sequence are made the maximum amounts. In such a case, the postprocessing sequence may be extended in view of a shift time of the external additive and the organosilicon polymer, and a free running distance of the intermediate transfer belt 10 may be extended.

### COMPARATIVE EXAMPLES

An effect obtained when the sequence in the present embodiment is executed is described with reference to Table 1, below, which shows the results of a print endurance test for the image forming apparatus during a two-sheet intermittent endurance operation, in a case where the sequence in the present embodiment is executed, and in a case where the sequence is not executed. Table 1 also shows image coverages of the respective image forming stations. By supplying toner when it is detected in each development device that a toner remaining amount reaches a fixed value, 50000 sheets in total were printed. At this time, the development device was not replaced, and only toner was supplied.

TABLE 1

| | | | | | | Supplied | Amount of | | |
|---|---|---|---|---|---|---|---|---|---|
| | | | | | | amount | toner used | Dropping | Toner |
| | | | | | | in one | in sequence | after | droppping |
| | Image Coverage | | | | Supply | supply | of printing | supply | in normal |
| | Y | M | C | Bk | Sequence | sequence | 50000 sheets | sequence | printing |
| Example 1-1 | 1% | 1% | 1% | 10% | This | 32 mm | 1600 mm | Not | Not |
| | | | | | sequence | | | occurred | occurred |
| Example 1-2 | 1% | 5% | 5% | 1% | This | 32 mm | 1600 mm | Not | Not |
| | | | | | sequence | | | occurred | occurred |
| Example 1-3 | 1% | 1% | 1% | 5% | This | 32 mm | 1600 mm | Not | Not |
| | | | | | sequence | | | occurred | occurred |
| Comparative | 1% | 1% | 1% | 10% | N/A | N/A | N/A | — | Occurred |
| Example 1 | | | | | | | | | |
| Comparative | 1% | 1% | 1% | 10% | Common | Each | 1600 mm | Occurred | Not |
| Example 2 | | | | | to all | color | | | occurred |
| | | | | | stations | 8 mm | | | |
| Comparative | 1% | 1% | 1% | 10% | Common | Each | 3200 mm | Not | Not |
| Example 3 | | | | | to all | color | | occurred | occurred |
| | | | | | stations | 16 mm | | | |

The used amount of 50000 sheets in Table 1 indicates an amount of toner used until the image forming apparatus prints 50000 sheets. Specifically, an amount of toner developed to be supplied to the blade in a supply sequence is represented as a total length corresponding to printing in the belt conveyance direction. In the blade width direction, a toner image is formed over the entire region of a printable range.

In Example 1-1 in Table 1, a supply sequence was executed using the method of the present embodiment. In Example 1-1, image coverages of the respective yellow, magenta, and cyan stations were all 1%, and an image coverage of a black station was 10%. A toner used amount used by a supply sequence of printing up to 50000 sheets was 1600 mm. The supply sequence is mostly performed by the black image forming station.

At the time of supply, toner dropping from the blade did not occur, and also at the time of a normal image formation, good cleaning behavior was shown up to 50000 sheets.

In Example 1-2 in Table 1, a supply sequence in the present embodiment was executed. In Example 1-2, image coverages of magenta and cyan were equal to 5%, and image coverages of yellow and black were 1%. In this case, toner is supplied to the blade mainly from a magenta station and a cyan station. In Example 1-2, similarly to Example 1-1, a toner used amount used by a supply sequence of printing 50000 sheets was 1600 mm.

At both times of the supply sequence and the normal image formation, toner dropping has not occurred.

In Example 1-3 in Table 1, a supply sequence in the present embodiment was executed. In Example 1-3, printing of 50000 sheets was similarly performed, but an image coverage of the black station during printing was halved from that in Example 1. Also in Example 1-3, a supply sequence was performed mainly from the black station. Nevertheless, as compared with Example 1-1, percentages of toner used for the supply sequence from the yellow, magenta, and cyan image forming stations have increased. At both times of the supply sequence and the normal image formation, toner dropping did not occur.

From the results of Examples 1-1 to 1-3, even if an image forming station used in the supply sequence varies, it was shown that printing of 50000 sheets could be executed without causing dropping. By performing selection of an image forming station reflecting a toner used amount, printing of 50000 sheets could be performed with an equal sequence usage amount.

As a comparative example, a case where image coverages of the respective image forming stations were the same as those in Example 1-1, but a supply sequence was not performed was executed as Comparative Example 1. Toner to be used for the supply sequence became nonexistent. Nevertheless, during normal image formation of printing of 30000 sheets or more, toner dropped from the intermediate transfer belt 10, and the dropping toner was sometimes printed in a white area.

Next, Comparative Example 2 was executed. Image coverages were the same as those in Example 1-1. Comparative Example 2 was executed in such a manner that, in the supply sequence, toner to be supplied is developed from each station by a width of 8 mm irrespective of an accumulated counter value. At this time, a toner amount used in the supply sequence until 50000 sheets printed was the same as those in Examples 1-1 and 1-2. In Comparative Example 2, printing of dropping toner in a white area at the time of normal image formation did not occur. Nevertheless, toner dropping sometimes occurred at the time of the supply sequence. At a timing at which toner supply for every 1000 sheets is performed, a reduction in an external additive and an organosilicon polymer existing on the blade can be considered as a reason. Then, if toner is supplied at this time from an image forming station with a small, accumulated counter value that contains a large amount of small particle diameter toner, toner dropping occurs.

As Comparative Example 3, toner with an equal amount is similarly supplied from each station in a supply sequence, and each printing length was 16 mm. Because toner dropping from the blade 16a might occur, a stable stationary layer 54 was expected to be formed using a larger amount of toner. As a result, toner dropping was not observed, but an amount of toner required for a supply sequence became larger as compared with those in Examples 1-1 to 1-3.

As shown in Examples 1-1 to 1-3 and Comparative Examples 1 to 3, toner with a large particle diameter can be expected to be preferentially supplied to the blade 16a, by selecting a station to be used in a supply sequence by using an accumulated counter value. It is considered that the amount of an external additive and an organosilicon polymer adhering to the blade 16a immediately before a supply sequence become smaller. By toner with a large particle diameter being supplied at this time, dropping risk is reduced. In addition, a blade behavior is stabilized by an external additive and an organosilicon polymer shifting from large particle diameter toner. Consequently, it is considered that an increase in supplied toner necessary for the stabilization is also suppressed.

As described above, in the examples, a supply sequence suitable for a total toner used amount of a process station was executed. This configuration prevents a supplied toner amount required for stabilization from becoming too large, while stabilizing the behavior of the blade through the operating life of the image forming apparatus.

In the present embodiment, in toner development executed at the time of the supply sequence, an exposure condition and a development condition that are the same as those in the case of printing a single-color solid image at the time of normal image formation were used. Nevertheless, halftone and a horizontal line pattern can also be used in a case where these are more suitable for stabilizing the behavior of the blade 16a.

In the present embodiment, a supply sequence was executed as a postprocessing sequence, which is a timing of a non-image-forming period. Nevertheless, an execution timing of the sequence is not limited to the postprocessing sequence. As a timing other than the postprocessing sequence, a page interval is increased at a predetermined timing during a print job, and the supply sequence may be executed at the timing. In addition, in a case where a command of the next print job is issued, the supply sequence may be executed as a preprocessing sequence, which is a timing of a non-image-forming period.

In addition, in the present embodiment, a station with the largest accumulated counter value was selected. Nevertheless, when a station L with the largest accumulated counter value is assumed to be a first station, an arbitrary station other than the station L may be selected as a second station. At this time, supplied toner from the first station L reaches the blade first. With this configuration, an external additive and an organosilicon polymer are supplied from toner estimated to have a large particle diameter that has reached the blade, and the stabilization of the blade behavior starts. Even if toner not always having a large particle diameter subsequently reaches the vicinity of the blade, the toner is prevented from entering a very-close position of the blade leading end. Nevertheless, toners from stations other than the station L are also circulated in the vicinity of the blade after the toners reach the vicinity of the blade. Accordingly, an external additive and an organosilicon polymer further shift, and these toners also contribute to the stabilization of the blade behavior. With this configuration, leveling for each color of toner to be used in the supply sequence is achieved.

As shown in Example 1-2, in a case where there are a plurality of stations L having the largest accumulated counter value, a station to be prioritized may also be selected referring to an average image coverage.

In this case, a station with a large average image coverage is selected preferentially. Even when the accumulated counter value is the same, as the number of printed sheets is smaller (i.e., an average image coverage is larger), an external additive and an organosilicon polymer on the surface of toner base particles are in a state of being unburied in the toner base particles. For this reason, these are easily shifted by the blade 16a, and these can contribute to the behavior stabilization of the blade 16a. In this manner, in the supply sequence, toner to be supplied is developed earlier from a station with a high average image coverage, and subsequently, toner to be supplied can be developed from a station with a low average image coverage.

### Second Embodiment

In the first embodiment, an accumulated counter value is calculated from an image coverage calculated from the entire image region, and an image forming station to be used in a supply sequence is determined. Nevertheless, a region where a toner image is formed is sometimes biased depending on a print image.

In this case, depending on a location in the longer direction where the blade 16a has contact with the intermediate transfer belt 10, it is possible that a region where an average particle diameter of toner in the development device 4a is large, and a region where an average particle diameter of toner in the development device 4a is small are mixed.

Thus, in the second embodiment, the blade 16a is divided in the longer direction, and an image coverage is counted.

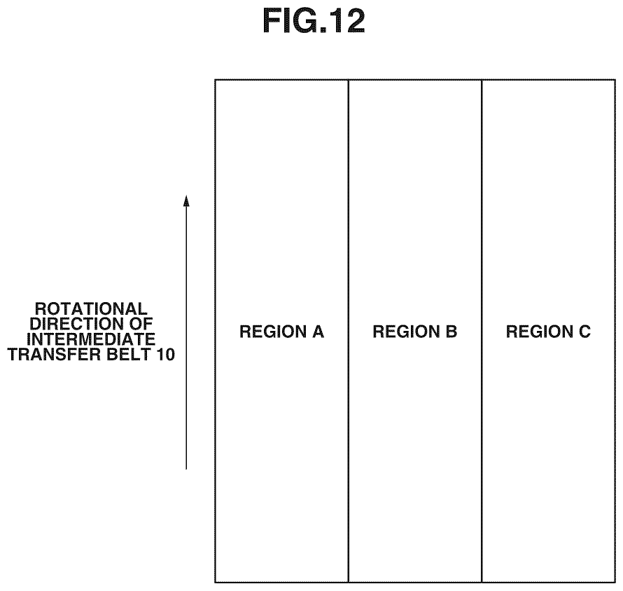

FIG. 12 illustrates a state in which a region is divided from one end side toward another end side in the longer direction in the present embodiment. The longer direction refers to a direction of a longer side of the blade 16a. The direction of the longer side also serves as a rotational axis direction of a rotating member such as the photosensitive drum 1, the development roller 42, the primary transfer roller 6, and the secondary transfer roller 20.

The divided regions indicate calculation regions of the accumulated counter value. In the present embodiment, the region is divided into three as an example. As illustrated in FIG. 12, a region A, a region B, and a region C are set with respect to the rotational direction of the intermediate transfer belt 10. The region A, the region B, and the region C may also be referred to as a first region, a second region, and a third region, respectively. To distinguish from the accumulated counter value of the first embodiment, the accumulated counter values of the respective regions are referred to as divided accumulated counter values. In the present embodiment, a divided accumulated counter value A, a divided accumulated counter value B, and a divided accumulated counter value C are calculated respectively for the three divided regions.

In the present embodiment, each divided accumulated counter value is calculated using a method similar to that in the first embodiment, and accumulated in accordance with an image coverage of each divided region.

In the present embodiment, a 5-mm margin is provided on each side of an LTR sheet. A region with a length of 68.7 mm from the left end of a region excluding the margins was set as the region A, a center 68.7-mm region was set as the region B, and a region with a length of 68.7 mm from the right end of the region excluding the margins was set as the region C.

### COMPARATIVE EXAMPLES

Table 2 shows an image coverage of each color, a supplied amount in one supply sequence, an amount of toner used in a supply sequence of printing 50000 sheets, and a cleaning result in the present embodiment.

TABLE 2

| | | | | | Supplied | Amount of | | |
|---|---|---|---|---|---|---|---|---|
| | | | | | amount | toner used | Dropping | Toner |
| | | | | | in one | in sequence | after | droppping |
| | Image Coverage | | | | supply | of printing | supply | in normal |
| | Y | M | C | Bk | sequence | 50000 sheets | sequence | printing |
| Region A | 0% | 15% | 0% | 1% | 30 mm | 1500 mm | Not | Not |
| | | | | | | | occurred | occurred |
| Region B | 0% | 0% | 15% | 1% | 30 mm | 1500 mm | Not | Not |
| | | | | | | | occurred | occurred |
| Region C | 15% | 0% | 0% | 1% | 30 mm | 1500 mm | Not | Not |
| | | | | | | | occurred | occurred |

As in the first embodiment, two-sheet intermittent printing of 50000 sheets was executed. In a toner supply sequence of the present embodiment, as an example, the following printing was performed. In the region A, printing of a 30-mm region was formed by the station M. In the region B, printing of a 30-mm region was formed by the station C. In the region C, a 30-mm region was formed by the station Y. There were timings at which the toner thus formed was supplied to the blade 16a.

A total toner used amount used in a supply sequence of printing up to 50000 sheets was 1500 mm in the conveyance direction, and at both times of the supply sequence and the normal printing, toner dropping did not occur.

In each region divided in a blade longer direction, a divided accumulated counter value of each image forming station is referred to. Then, a station with a large divided accumulated counter value is each selected, and a supply sequence is performed, whereby the blade behavior can be stabilized more effectively.

### Third Embodiment

In a case where printing with a low image coverage is continuously performed in an image forming apparatus, the possibility of toner dropping from the blade 16a as well as the possibility of the blade peel-off in which the blade is peeled off increases.

To prevent this, toner is also supplied to the blade 16a, and an external additive and an organosilicon polymer are shifted to the blade 16a from the toner that has reached the blade 16a. The wear of the blade 16a and the intermediate transfer belt 10 is thereby reduced, and peel-off is prevented. Because the blade peel-off easily occurs from the end portion in the longer direction, the blade behavior can be stabilized by supplying toner to the end portion.

It is assumed that the printing with a low image coverage is continued in succession, and at a timing earlier than the printing, a difference in accumulated counter value is generated among the regions A, B, and C. In such a case, toner is supplied from a station with large, accumulated counter values in the regions A and C. Region division and accumulated counter values are determined using the same method as those in the first and second embodiments. Nevertheless, a divided width of an end portion may be set to a narrow width by placing more importance on the peel-off at the end portion. If a state in which an image coverage is low continues, an amount of the stationary layer 54 at the leading end of the blade 16a also becomes smaller. Accordingly, the blade 16a becomes more likely to be peeled off, and toner dropping becomes more likely to occur. For this reason, preferentially supplying large particle diameter toner from a station with a large divided accumulated counter value becomes effective as a countermeasure. For the peel-off, an interval of the supply sequence is not limited to 1000 sheets, and the sequence may be appropriately executed at a timing at which a torque of an intermediate transfer belt starts to rise. At this time, in a central portion where the occurrence possibility of peel-off is low, toner supply may be omitted. With this configuration, an amount of toner to be used to prevent peel-off can be saved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-030142, filed Feb. 27, 2025, which is hereby incorporated by reference herein in its entirety.

What is claimed is:

1. An image forming apparatus comprising:
a first image forming station;
a second image forming station;
an intermediate transfer belt;
an abutting member; and
a secondary transfer roller,
wherein:
the first image forming station includes:
a first photosensitive drum configured to bear at least a portion of an image;
a first development container configured to accommodate first toner;
a first development roller configured to bear the first toner and develop a first toner image on the first photosensitive drum; and
a first primary transfer member, and
the second image forming station includes:
a second photosensitive drum configured to bear at least a portion of the image;
a second development container configured to accommodate second toner;
a second development roller configured to bear the second toner and develop a second toner image on the second photosensitive drum; and
a second primary transfer member,
the first toner image developed on the first photosensitive drum is primarily transferred to the intermediate transfer belt by a first primary transfer roller,
the second toner image developed on the second photosensitive drum is primarily transferred to the intermediate transfer belt by a second primary transfer roller,
the first toner image and the second toner image that have been primarily transferred to the intermediate transfer belt are secondarily transferred by the secondary transfer roller to a transfer material, and
the abutting member is configured to contact the intermediate transfer belt and collect residual toner from the intermediate transfer belt after the first toner image and the second toner image are transferred to the transfer material,
an accumulated value of a used amount of the first toner in the first image forming station is a first total toner used amount, and an accumulated value of a used amount of second toner in the second image forming station is a second total toner used amount,
when the first total toner used amount is larger than the second total toner used amount, first toner is supplied to the abutting member from the first image forming station via the intermediate transfer belt in at least one non-image-forming period, and
in a region of the intermediate transfer belt to which the first toner image and the second toner image are primarily transferred, one end side in a rotational axis direction of the secondary transfer roller is a first region, and another end side excluding the first region is a second region, and
when the first total toner used amount is larger than the second total toner used amount in the first region and the first total toner used amount is less than the second total toner used amount in the second region, first toner is supplied in the first region to the intermediate transfer belt from the first image forming station in at least one non-image-forming period, and second toner is supplied in the second region to the intermediate transfer belt from the second image forming station in at least one non-image-forming period.

2. The image forming apparatus according to claim 1, wherein:
the other end side in the second region in the rotational axis direction is a third region, and
in a case where the first total toner used amount is larger than the second total toner used amount in the third region, irrespective of the first total toner used amount and the second total toner used amount in the first region and the second region, the first toner is supplied, in the third region, to the intermediate transfer belt from the first image forming station in at least one non-image-forming period.

3. The image forming apparatus according to claim 1, wherein:
when a first image coverage for one transfer material in the first image forming station is smaller than a second image coverage for one transfer material in the second image forming station and when the first total toner used amount is larger than the second total toner used amount, the first toner is supplied to the abutting member from the first image forming station via the intermediate transfer belt in at least one non-image-forming period.

4. The image forming apparatus according to claim 1, wherein:
when a first image coverage for one transfer material in the first image forming station is smaller than a second image coverage for one transfer material in the second image forming station in the first region and when the first total toner used amount is larger than the second total toner used amount in the first region, the first toner is supplied, in the first region, to the intermediate transfer belt from the first image forming station in at least one non-image-forming period.

5. The image forming apparatus according to claim 1, wherein:
the first image forming station includes a first toner supply container configured to supply the first toner to the first development container,
the second image forming station includes a second toner supply container configured to supply the second toner to the second development container, and
before the first toner is supplied to the first development container, the first total toner used amount is larger than the second total toner used amount,
after the first toner is supplied to the first development container, a result obtained by multiplying a toner amount by the first total toner used amount is set as the first total toner used amount, the toner amount including an amount of the first toner of the first development container before supply divided by an amount of the first toner of the first development container after supply, and
when the first total toner used amount is less than the second total toner used amount, the second toner is supplied to the abutting member from the second image forming station via the intermediate transfer belt in at least one non-image-forming period.

6. The image forming apparatus according to claim 1, wherein:
the first image forming station includes a first toner supply container configured to supply the first toner to the first development container, and
the second image forming station includes a second toner supply container configured to supply the second toner to the second development container,
in a region of the intermediate transfer belt to which the first toner image and the second toner image are primarily transferred, one end side in a rotational axis direction of the secondary transfer roller is regarded as a first region and another end side excluding the first region is regarded as a second region,
in the first region, before and after the first toner is supplied to the first development container, the first total toner used amount is larger than the second total toner used amount,
a result obtained by multiplying a toner amount by the first total toner used amount is set as the first total toner used amount,
when the first total toner used amount is less than the second total toner used amount, in the second region, before the first toner is supplied to the first development container, the first total toner used amount is larger than the second total toner used amount, and after the first toner is supplied to the first development container, a result obtained by multiplying the toner amount by the first total toner used amount is set as the first total toner used amount,
when the first total toner used amount is larger than the second total toner used amount, the second toner is supplied, in the first region, to the intermediate transfer belt from the second image forming station in at least one non-image-forming period, and
the toner amount includes an amount of the first toner of the first development container before supply divided by an amount of the first toner of the first development container after supply.

7. The image forming apparatus according to claim 1, wherein, when the first total toner used amount is larger than the second total toner used amount, the first toner is supplied to the first photosensitive drum from the first development roller, and the second toner is not supplied to the second photosensitive drum from the second development roller:
the first toner is supplied to the abutting member from the first image forming station via the intermediate transfer belt in at least one non-image-forming period.

8. The image forming apparatus according to claim 1, wherein, when the first total toner used amount is larger than the second total toner used amount in the first region and the first total toner used amount is less than the second total toner used amount in the second region: in the first region, the first toner is supplied to the first photosensitive drum from the first development roller, and the second toner is not supplied to the second photosensitive drum from the second development roller, the first toner is supplied to the intermediate transfer belt from the first image forming station in at least one non-image-forming period, and
in the second region, the first toner is not supplied to the first photosensitive drum from the first development roller, and by second toner being supplied to the second photosensitive drum from the second development roller, second toner is supplied to the intermediate transfer belt from the second image forming station in at least one non-image-forming period.

9. An image forming apparatus comprising:
a first image forming station including a first photosensitive drum configured to bear at least a portion of an image, and a first development roller configured to bear first toner and develop a first toner image on the first photosensitive drum;
a second image forming station including a second photosensitive drum configured to bear at least a portion of the image, and a second development roller configured to bear second toner and develop a second toner image on the second photosensitive drum;
an intermediate transfer belt; and
an abutting member configured to contact and collect residual toner remaining on the intermediate transfer belt after transfer of the first toner image and the second toner image, wherein:
the first toner image and the second toner image are transferred to the intermediate transfer belt by respective transfer rollers,
an accumulated value of a used amount of the first toner in the first image forming station is a first total toner used amount,
an accumulated value of a used amount of second toner in the second image forming station is a second total toner used amount, and
when the first total toner used amount is larger than the second total toner used amount, first toner is supplied to the abutting member from the first image forming station via the intermediate transfer belt in at least one non-image-forming period.

10. An image forming apparatus comprising:
a first image forming station;
a second image forming station;
an intermediate transfer belt;
an abutting member; and
a secondary transfer roller, wherein:
the first image forming station includes:
a first photosensitive drum configured to bear at least a portion of an image;
a first development container configured to accommodate first toner; and
a first development roller configured to bear the first toner and develop a first toner image on the first photosensitive drum,
the second image forming station includes:
a second photosensitive drum configured to bear at least a portion of the image;
a second development container configured to accommodate second toner; and
a second development roller configured to bear the second toner and develop a second toner image on the second photosensitive drum,
the first toner image developed on the first photosensitive drum is primarily transferred to the intermediate transfer belt by a first primary transfer roller,
the second toner image developed on the second photosensitive drum is primarily transferred to the intermediate transfer belt by a second primary transfer roller,
the first toner image and the second toner image that have been primarily transferred to the intermediate transfer belt are secondarily transferred by the secondary transfer roller to a transfer material, and
the abutting member is configured to contact the intermediate transfer belt and collect residual toner from the intermediate transfer belt after the first toner image and the second toner image are transferred to the transfer material,
in a region of the intermediate transfer belt to which the first toner image and the second toner image are primarily transferred, one end side in a rotational axis direction of the secondary transfer roller is a first region, and another end side excluding the first region is a second region, and
when a first total toner used amount is larger than a second total toner used amount in the first region and the first total toner used amount is less than the second total toner used amount in the second region, first toner is supplied in the first region to the intermediate transfer belt from the first image forming station in at least one non-image-forming period, and second toner is supplied in the second region to the intermediate transfer belt from the second image forming station in at least one non-image-forming period.
